(19) United States
(12) Patent Application Publication
(10) Pub. No.: US 2008/0175003 A1
(43) Pub. Date: Jul. 24, 2008

(54) Led sunken lamp

(75) Inventors: Tung-Hsing Tsou, Hsinchu County (TW); Chang-Lung Li, Hsinchu County (TW)

Correspondence Address: Joe McKinney Muncy, PO Box 1364, Fairfax, VA, 22038-1364, US

(73) Assignee: CHENG HOME ELECTRONICS CO., LTD.

(21) Appl. No.: 11/655,853

(22) Filed: Jan. 22, 2007

(51) Int. Cl. F21V 29/00

(52) U.S. Cl. 362/294

(57) ABSTRACT

A LED sunken lamp includes a case and a lighting assembly. The case includes a lamp shade and a case seat. The lamp shade is wedged in the case seat. The lighting assembly also is wedged in the case seat and includes at least a LED lamp and a circuit board that are electrically connected. The case seat can be disassembled to facilitate wedging of the lamp shade and the lighting assembly in the case seat. The case seat also has a plurality of radiation fins to disperse heat energy generated by the LED lamp when in use to increase the life span of the LED lamp.

### FIELD OF THE INVENTION

The present invention relates to a sunken lamp and particularly to a sunken lamp that uses LED as the light source.

### BACKGROUND OF THE INVENTION

The halogen lamp used in the conventional lighting fixtures generally uses tungsten as the lighting source. It is simply structured and inexpensive, thus is well accepted on the market. However it generates a lot heat and consumes a great amount of electric power when in use. The light source is not stable and the lift span is shorter. Hence it is not desirable in the circumstance which needs a stable light source for a prolonged period of time. On the other hand, LED (Light Emitting Diode) lamp has a smaller size, consumes less electric power and can generate steady light. It is an excellent choice of the light source. The technology for fabrication LED lamp is well developed now, and the price drops constantly. Hence it gradually replaces the conventional lamp and is widely used as the lighting source for various types of lighting fixtures, such as flash light, vehicle light, sunken lamp, projection light or the like.

However heat dissipation still is an obstacle in the application of LED lamp. Take a high performance (GaN) LED as an example. After the LED lamp is energized by electricity only a small portion of electric power is converted to light. Most of the electric power is converted to heat energy. As the life span and light source stability are affected by the temperature, if the generated heat energy cannot be dispersed effectively the applicability of the LED lamp will be limited. At present most products that use the LED lamp as the light source usually are coupled with a cooling apparatus. For instance R.O.C. patent No. M300866 discloses a LED lighting fixture with multi-heating-tube radiation structure to dissipate heat. The radiation structure includes a heat receiving dock and a plurality of heating tubes. The heat receiving dock is connected to a LED lamp and the heating tubes. The heat energy generated by the LED is transmitted to the heating tubes through the heat receiving dock, and finally dissipated in the atmosphere. R.O.C. patent No. M276320 discloses another type of LED lighting fixture which has a plurality of cooling apparatus that include a metal heat dissipating fin assembly and a case seat made from heat dissipating ceramics. The heat energy generated by the LED is dispersed through those two types of cooling apparatus. R.O.C. patent No. M296342 also discloses yet another sunken lamp structure which has a plurality of heat dissipating fins surrounding a case to perform heat exchange with air for the heat energy generated by the LED.

All the conventional LED heat dissipating apparatus mentioned above aim to rapidly dissipate heat when the LED is energized by electricity to stabilize the LED lighting source and increase the life span. However, the aforesaid LED lamp equipped with the cooling apparatus focus heat dissipation function at the expense of more complicated structure. Not only fabrication process is more complex, assembly also is more difficult. Although the LED lamp can last longer than the conventional lamp, malfunction and damage still will occur. When the LED lamp is used in the household environment, to replace the LED lamp is a difficult task for users. The entire lighting fixture has to be replaced. Repair and maintenance cost is higher.

### SUMMARY OF THE INVENTION

In view of the problem occurred to the conventional LED lighting fixtures equipped with cooling apparatus that have a complicated structure and difficult to disassemble for users to replace the damaged lamp, the primary object of the present invention is to provide a LED lamp set that is simply structured and easy to install and disassemble to facilitate repairs and maintenance. To achieve the foregoing object, the invention provides a LED sunken lamp which includes a case and a lighting assembly. The case includes a lamp shade and a case seat. The case seat has a housing groove. The lamp shade and the lighting assembly are wedged in the case seat. The lighting assembly includes at least one LED lamp and a circuit board that are electrically connected. The case seat can be disassembled to facilitate wedging of the lamp shade and lighting assembly. The case seat has a plurality of heat dissipating fins to performing heat dispersion for the LED lamp to increase the life span of the LED lamp.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the LED sunken lamp of the invention.

FIG. 2 is an exploded view of the LED sunken lamp of the invention.

FIG. 3 is a schematic view of the LED sunken lamp of the invention in a first assembly condition.

FIG. 4 is a schematic view of the LED sunken lamp of the invention in a second assembly condition.

FIG. 5 is a schematic view of the LED sunken lamp of the invention in a third assembly condition.

### DETAILED DESCRIPTION OF THE PREFERRED EMBODIMENTS

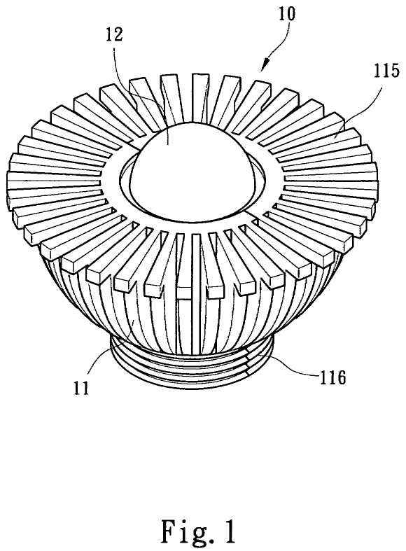

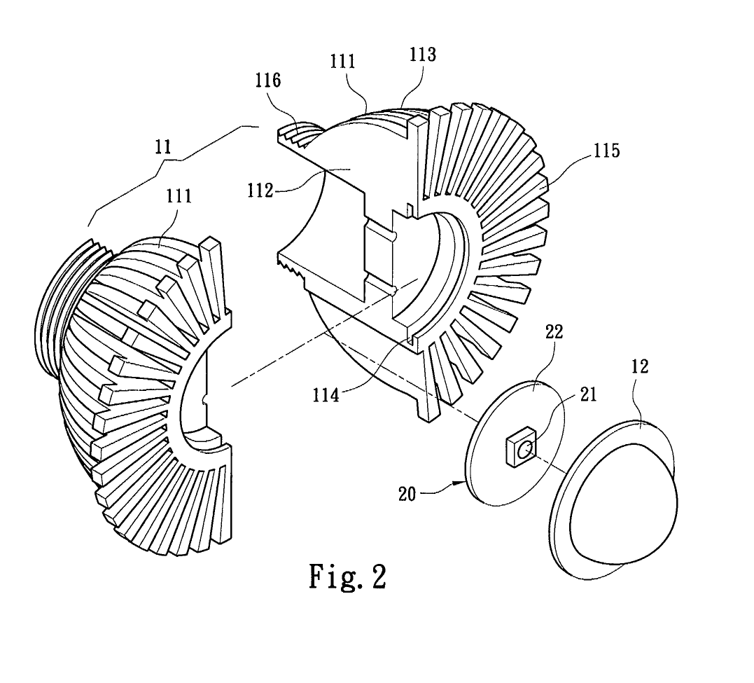

Please refer to FIGS. 1 and 2, the LED sunken lamp according to the invention includes a case 10 and a lighting assembly 20. The case 10 includes a case seat 11 and a lamp shade 12. The lighting assembly 20 includes at least one LED lamp 21 and a circuit board 22 that are electrically connected. The case seat 11 can be disassembled and includes two coupling units 111. Each of the coupling units 111 has a coupling surface 112 and a radiation surface 113. The coupling surface 112 has a housing groove 114 formed thereon to be wedged in by the lamp shade 12 and the lighting assembly 20. The housing groove 114 is a narrow ditch such that the lamp shade 12 and the lighting assembly 20 can be held therein without escaping. The radiation surface 113 has a plurality of heat dissipating fins 115 formed on an outer side annularly that are equally spaced from one another to surround the two coupling units 111 to serve as a heat dissipation means to rapidly disperse the heat generated by the LED lamp 21 into the atmosphere.

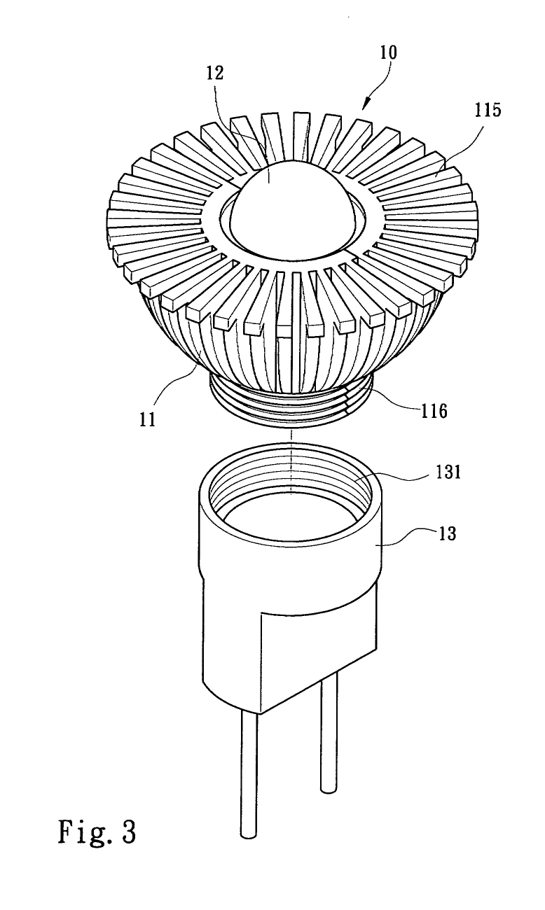

Refer to FIG. 3 for a first assembly condition of the LED sunken lamp of the invention. The case 10 has a relay assembly 13 attached thereon that is electrically connected to the LED lamp 21 and the circuit board 22, and also aids assembly of the two coupling units 111. Each of the coupling units 111 has a first thread structure 116 formed on one end. The relay assembly 13 also has a corresponding second thread structure 131. After the lighting assembly 20 and the lamp shade 12 are wedged in one set of the coupling units 111, another set of the coupling unit 111 can be coupled to anchor the lighting assembly 20 and the lamp shade 12 on the case seat 11. The first thread structure 116 is semi-circular. After the two portions are coupled, they become a circular thread structure to be engaged with the second thread structure 131 of the relay assembly 13 so that the two sets of coupling units 111 are coupled closely to hold the wedged lamp shade 12 and lighting assembly 20 securely without escaping. Then assembly of the LED sunken lamp is finished.

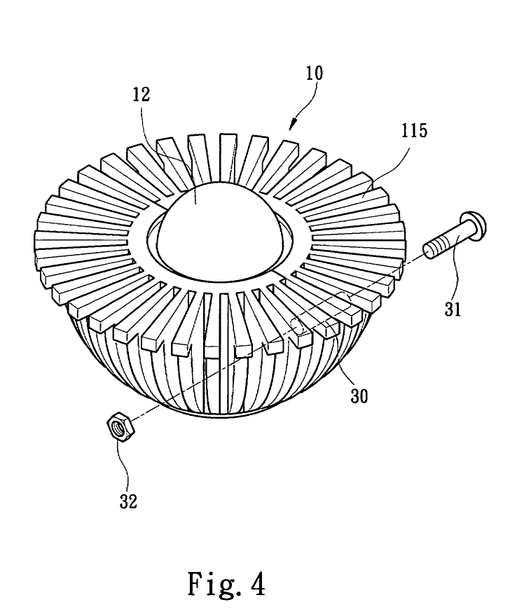

Refer to FIG. 4 for a second assembly condition of the LED lamp. In this embodiment the two sets of the coupling units 111 have respectively a threaded passage 30 formed therein running through the heat dissipating fins 115. After the lamp shade 12 and the lighting assembly 20 are wedged in the two coupling units 111, the threaded passage 30 may be run through by a bolt 31 which is coupled with a nut 32 and anchored between the heat dissipating fins 115. Thereby the two coupling units 111 are fastened firmly to finish assembly of the LED sunken lamp.

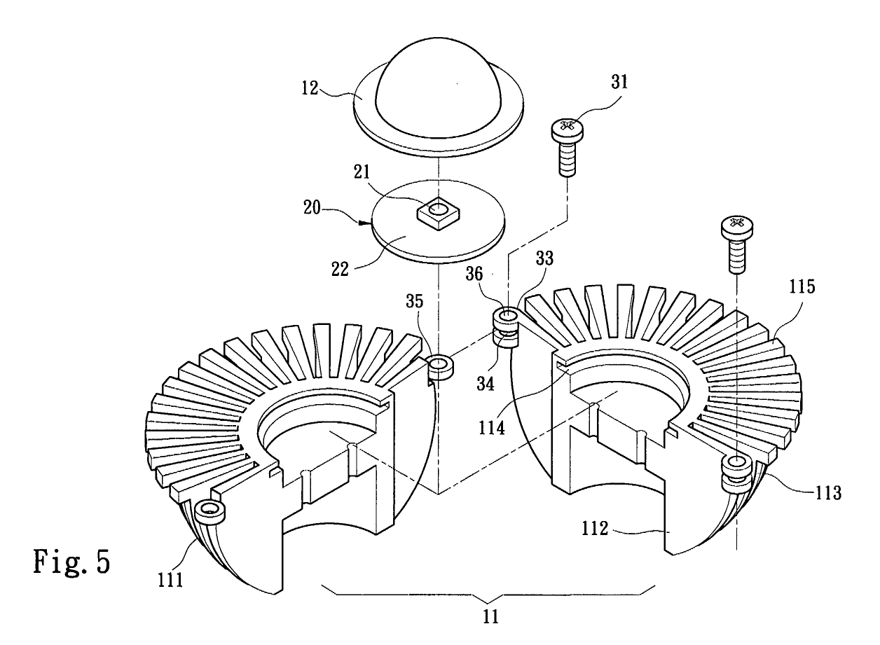

Refer to FIG. 5 for a third assembly condition of the LED lamp. In this embodiment each coupling unit 111 has a first bolting portion 33 and a second bolting portion 35 on the edge of the heat dissipating fins 115 close to the coupling surface 112. The first bolting portion 33 has a holding space 34 to be wedged in by the second bolting portion 35. The first and second bolting portions 33 and 35 have respectively a bolt orifice 36 to engage with a bolt 31. After the lamp shade 12 and lighting assembly 20 are wedged in the two coupling units 111, the second bolting portion 35 also is wedged in the holding space 34 of the first bolting portion 33. The bolt orifice 36 is a through passage to receive the bolt 31 so that the two coupling units 111 can be fastened firmly to finish assembly of the LED sunken lamp.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A LED sunken lamp comprising a case and a lighting assembly, the case including a lamp shade and a case seat, the lighting assembly including at least a LED lamp and a circuit board that are electrically connected;
wherein the case seat is allowed to be disassembled and has a housing groove and a plurality of heating dissipating fins, the lamp shade and the lighting assembly being wedged in the housing groove and installed on the case seat.

2. The LED sunken lamp of claim 1, wherein the case seat is coupled with a relay assembly which has a second thread structure, the case seat having a first thread structure corresponding to and engageable with the second thread structure.

3. The LED sunken lamp of claim 2, wherein the relay assembly, the LED lamp and the circuit board are electrically connected.

4. The LED sunken lamp of claim 1, wherein the case seat has corresponding bolting structures to be fastened through a bolt.
